(19) United States
(12) Patent Application Publication
(10) Pub. No.: US 2010/0176604 A1
(43) Pub. Date: Jul. 15, 2010

(54) Pressure and Rotation Activated Electrical Power Generation System

(76) Inventor: Andres E. Bravo, Pompano Beach, FL (US)

Correspondence Address: Andres E. Bravo, 1050 NW 49th Street, Pompano Beach, FL, 33064, US

(21) Appl. No.: 12/351,915

(22) Filed: Jan. 12, 2009

(51) Int. Cl. H02K 7/18; B60Q 1/26

(52) U.S. Cl. 290/1 R; 315/78

(57) ABSTRACT

The invention concerns mainly the utilization of gravity, more specifically the weight of a vehicle and the rotation of the wheels that support the vehicle during its motion to produce an electric current within the wheels to be utilized by the vehicle's electrical requirements. The power generation would exist at all times during the motion of the vehicle and could greatly increase the range of electric and electric hybrid vehicles, as well as increasing the MPG of combustion vehicles by reducing the mechanical power consumption of the power generator (alternator) currently utilized to recharge the vehicle's battery. A similarity in all existing terrestrial vehicles which use contact with a surface as the medium and method of transportation is the existence of the weight of the vehicle which forces a pressure against that surface during the mobilization of the vehicle. This downward force contributes as an additional friction working against the efficiency of the locomotion of the vehicle. By utilizing the pressure created at the tangent where the wheel meets the supporting surface through a system of pressure activated power generators positioned within the wheels, an electric current is created which can increase the efficiency of the vehicle without introducing additional friction to the motion of the vehicle due to the fact that the downward force created by gravity exists at all times regardless of the configuration of the vehicle.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The creation of the invention occurred as a consequence of increasing needs to maximize the efficiency of existing transportation and other mechanical systems as the resources which energize those systems continue to diminish. The invention basically utilizes existing forces and frictions to benefit the function of the system which they are created from and working against. By employing an assembly of pressure sensitive devices within a rotating system which experiences constant pressures at a known location on the system, an electrical signal or current can be created while both the rotation and the pressure exist. For all road vehicles that utilize a system of wheels as a means for mobilization, the deformation which occurs at the contact point between the wheel and the supporting surface can be interpreted as a change in the distance between the road and the point of axis, more specifically, a reduction in the wheel's diameter at that point. During the rotation of the wheel, that change to the wheel's diameter can be considered a linear oscillating motion at specific points along the inner circumference of the wheel, which can be picked up by a magnetic or piezo sensor and translated into an electrical current.

Since the weight of the vast majority of all surface vehicles used in the transportation of personnel, goods, or any other requirement that necessitates a complex mechanical configuration for the vehicle exceeds hundreds or thousands of pounds, the force which deforms the wheels on the point of contact is significant, and the requirement to activate the internal pressure activated power generators within the wheels is relatively insignificant, likely only a few ounces, and would therefore not contribute to the energy consumption of the vehicle. Moreover, the power generators would be utilizing an already existing friction and force, being the tire deformation occurring from the weight of the vehicle to provide the electrical current that would increase the efficiency of the vehicle.

The utilization of power generation from pressure and rotation would not be limited to vehicles, and could be utilized in any mechanical system where a rotating wheel is in forced contact with another surface, where the amount of force is not determined by the electrical but rather the mechanical requirements of the system, and the electrical power generation would be a secondary benefit.

### BRIEF SUMMARY OF THE INVENTION

The primary object of the invention is to convert the rotational motion of a wheel, and the weight which it supports into electrical energy.

By utilizing a system of pressure sensors positioned between the weight of the object supported by the wheel, and the surface which supports the wheel, while harnessing the rotation of the wheel itself, an electrical signal can be created as the wheel rotates and exposes the sensors to consistently occurring pressure at every instance that the sensor aligns to the contact point between the supporting surface and the weight supporting wheel.

The transformation of mechanical pressure and rotation energy into electrical energy will be described utilizing two methods, and array of internal pressure sensors and a continuous circular system both circumscribed about the outer surface of a wheel where they can experience both the needed pressure and rotation that will activate them.

Since the application of this invention is focused mainly on motor vehicles, the fundamental concept and related configurations described will be taking into account the use of a wheel rim supporting an inflated rubber tire. The road surfaces which will support the wheel assembly and provide the medium for the mobilization of the vehicle will be present with imperfections, and since the wheel assembly will utilize an inflated tire which in certain instances could lose air pressure or experience unforeseen ranges of deformation, the arrangement of the power generators within the wheel assembly will have to be configured to account for all scenarios to prevent the destruction of the generator system. In consideration of preventing damaging the generator system, rubber and/or metal spring dampeners will be allocated to each generator or pressure point where in the worse case, in the event of total deformation and collapse of the tire, the generators would remain protected within the rim of the wheel and only the additional range of motion of the dampeners would feel the effect.

The array of electric power generators would exist as a collection of multiple units, quantity determined by the electrical requirements of the vehicle, positioned inside of the wheel assembly along the outer circumference of the wheel and the inner circumference of the inflated rubber tire which is supported by the wheel. The activation of each generator would occur at the contact point between the wheel and the supporting surface (road) where the weight of the vehicle creates a pressure and deformation of the tire at that contact point. Both magnetic coil and piezo generators would utilize similar dampening methods but a configuration could be applied with a piezo generator where an inner tube resides within the wheel and tire assembly and the piezo cells would be positioned between the outer circumference of the inner tube and the inner circumference of the tire, and the dampening method would be the air pressure within the inner tube. For the configuration utilizing an array of internal power generators, a fundamental requirement of the pressure and rotation activated electrical power generation system is not only that the power generators be positioned between the weight of the object and surface supporting the object during the rotation of the wheel in which they are encased, but that each generator in the array transmit energy only to the receiving system, and not every other generator. To achieve a transmitted signal that is exclusive to the assigned receiving end, the vehicle for example, either a contact switch will be used at the end of the power generator where the pressure increase is detected to close the circuit between that generator and the receiver, or a solid state signal gate system between the generator and the point where the signals of all generators meet to a common point will be utilized to allow only that generator to transmit to the receiver as it comes into contact with the pressure area.

The second method for converting pressure and rotation into an electrical current will be to utilize a continuous ring, wound with magnetic wire, fixed and circumscribed about the outer surface of the rotating wheel, exposed to a concentrically aligned oscillating outer ring supporting an array of permanent magnets. As the wheel rotates, with the weight which it is supporting deforming the wheel at the point where the wheel meets the supporting surface, a set of pivot points transform the linear oscillating motion at various points along the inner circumference of the wheel at the point of deformation into an oscillating axial motion which would then transfer to the outer magnetic array ring, that is concentrically positioned outside of the power generator ring, wound with magnetic wire.

With both the solenoid array and the oscillating ring power generation configurations, what basically occurring is a moving magnetic field across the proximity of a charge carrying medium, the magnetic wire, creating an electrical current. The generated electrical current will reach the receiver as a waveform signal since each generator will only create either an A/C or D/C pulse from a solenoid or piezo configuration, respectively. It is likely that a rectifier and/or electrical condenser system would have to be applied to convert the signal to a stable form that would best be accepted and utilized by the receiver.

In order to transmit the electric current produced by the power generation system to the receiver, where the power generator is fixed to a wheel which rotates relative to a static frame that supports it and houses he receiver, a brush and collector ring configuration can be utilized where the brush assembly is fixed to the wheel at the transmitting end, which would then be in electrical contact with the collector rings at the receiving end which are fixed to the wheel axel at the spindle where it protrudes out the front of the wheel. The wiring from the collector ring bearing assembly would traverse through the center of the spindle/axle to the receiver attached to the static frame. The brush/collector ring assembly will be comprised of only a positive and negative channel which is how the receiver will accept the signal. An alternate method to transmit the electrical current produced by the generators to the receiver would be through induction, where each generator in the array within the wheel would be in contact with a transmitting coil attached to the wheel at the outer vertical rim of the wheel in a position and location where it is in close proximity with a receiver coil attached to the static frame that supports the wheel. Both methods to transfer the electrical energy from the power generators within the rotating wheel to the static frame could be applied to either a magnetic coil or piezo generator since each produce a pulsed waveform signal, which for an induction assembly is required as only a dynamic magnetic flux is allowed for induction to occur.

The level of electrical energy produced by the wheel assembly would be determined by the weight of the vehicle and rotation of the wheels during the mobilization of the vehicle. For that reason, at all times during the motion of the vehicle, electrical energy would be returned back to the vehicle and since the pressure requirements of the generators is minimal and the weight of the vehicle overwhelms the requirement of the generator, no additional power requirements from the vehicle would be needed to activate the generators. More specifically the generators would be utilizing already existing weight and friction to return the energy that is lost back to the vehicle. The utilization of the rotation and pressure activated power generation system could also be applied to trains or any other vehicle that utilizes wheels for mobilization as well as any non vehicular machinery where a rotating wheel is in constant contact with significant pressure to another surface.

### BRIEF DESCRIPTION OF THE DRAWINGS

In the drawings:

FIG. 1 shows a side view of the magnetic coil (solenoid) power generation system as seen applied to a wheel and inflated rubber tire configuration.

FIG. 2 shows a section view of the magnetic coil (solenoid) power generation system as seen applied to a wheel and inflated rubber tire configuration.

FIG. 3 shows another embodiment variant similar to that in FIG. 1, with a piezo cell power generation system as seen applied to a wheel and inflated rubber tire configuration.

FIG. 4 shows another embodiment variant similar to that in FIG. 2, with a piezo cell power generation system as seen applied to a wheel and inflated rubber tire configuration.

FIG. 5 shows another embodiment variant similar to that in FIG. 1, with a piezo cell power generation system as seen applied to a wheel and inflated inner tube within a rubber tire configuration.

FIG. 6 shows another embodiment variant similar to that in FIG. 2, with a piezo cell power generation system as seen applied to a wheel and inflated inner tube within a rubber tire configuration.

FIG. 7 shows a side view of the magnetic ring coil power generation system as seen applied to a wheel and inflated rubber tire configuration.

FIG. 8 shows a section view of the magnetic ring coil power generation system as seen applied to a wheel and inflated rubber tire configuration.

FIG. 9 shows a detailed view of the piezo cell power generation system as seen applied to a wheel and inflated inner tube within a rubber tire configuration.

FIG. 10 shows a detailed view of the piezo cell power generation system as seen applied to a wheel and rubber tire configuration.

FIG. 11 shows another embodiment variant similar to that in FIGS. 9 and 10, with multiple piezo cells mounted atop each other as seen applied to a wheel and rubber tire configuration.

FIG. 12 shows a detailed view of the magnetic coil (solenoid) power generation system as seen applied to a wheel and rubber tire configuration.

FIG. 13 shows a detailed view of the magnetic ring coils power generation system as seen a wheel and inflated inner tube within a rubber tire configuration.

FIG. 14 shows an electrical schematic diagram to briefly summarize the concept of utilizing an electrical contact pressure activated switch to close the circuit between the transmitter and receiver for each solenoid sensor in the array as seen applied to a wheel and rubber tire configuration, to include the use of an inner tube as described in FIG. 9.

FIG. 15 shows an electrical schematic diagram to briefly summarize the concept of utilizing a solid state gate system to close the circuit between the transmitter and receiver for each solenoid sensor in the array as seen applied to a wheel and rubber tire configuration, to include the use of an inner tube as described in FIG. 9.

FIG. 16 shows an electrical schematic diagram to briefly summarize the concept of utilizing an electrical contact pressure activated switch to close the circuit between the transmitter and receiver for each piezo cell in the array as seen applied to a wheel and rubber tire configuration, to include the use of an inner tube as described in FIG. 9.

FIG. 17 shows an electrical schematic diagram to briefly summarize the concept of utilizing a solid state gate system to close the circuit between the transmitter and receiver for each piezo cell in the array as seen applied to a wheel and rubber tire configuration, to include the use of an inner tube as described in FIG. 9.

### DETAILED DESCRIPTION OF THE INVENTION

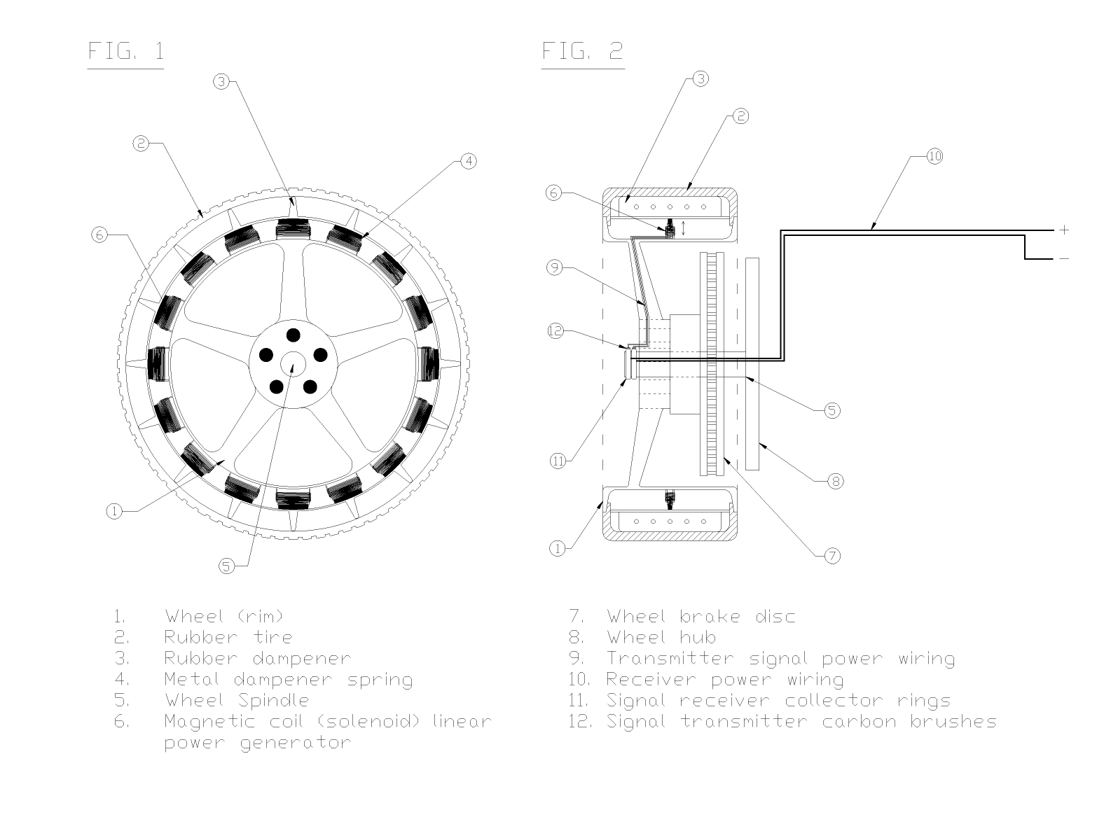

According to FIGS. 1, 3, 5, and 7, the power generation assembly is described for use with a metal wheel 1 supporting a rubber tire 2, where the action of the deformation of the rubber tire 2 by the weight it supports is utilized to activate the generators 6.

According to FIG. 1, the use of an array of magnetic coil generators (solenoids) 6, placed rigid to the wheel 1 via mechanical bolted connection along the outer circumference of the wheel 1, between the wheel 1 and the inner circumference of the rubber tire 2. The linear motion required to activate the solenoid 6 at the contact point between the tire 2 and supporting surface or road is accomplished via a rubber dampener system 3 which is employed to absorb additional ranges of deformation of the tire 2, and subsequent excessive linear motion. The solenoid 6 could also utilize metal dampening spring 4 in the event that the additional range of motion is beyond that which can be absorbed by the rubber dampener 3. The rubber dampener 3 would be positioned inscribed within the inner circumference of the rubber tire 2, between and in direct contact with the solenoid 6 and rubber tire 2, attached rigid o the solenoid 6 to maintain alignment of the dampener 3 vane and power generating solenoid 6. Transmission of the electric current or signal from the transmitting source, or solenoid 6, and the receiver or vehicle requires a method where a dynamic rotating source can accomplish an electrical contact with a static object. For this to occur, a system of carbon brushes 12 connected at the end of the transmitter wiring 9 opposite to the solenoid generators 6, where each brush attaches to either a positive or negative channel or wire 9, attached rigid to the rotating wheel 1, are in constant contact with a set of collector rings 11, fixed rigid to the static receiver at the wheel spindle 5, with the receiver signal wiring 10 connected to the collector rings 11 traversing through the center of the spindle 5, and closing the electrical circuit with the receiver and supplying a compliment to supply the receiver's electrical requirements. The orientation of the solenoid 6, along the circumference of the wheel 1 can be determined by the application, to include the type of solenoid 6, and quantities utilized along the circumference, to include the use of multiple solenoids 6 at every radial point along the wheel 1.

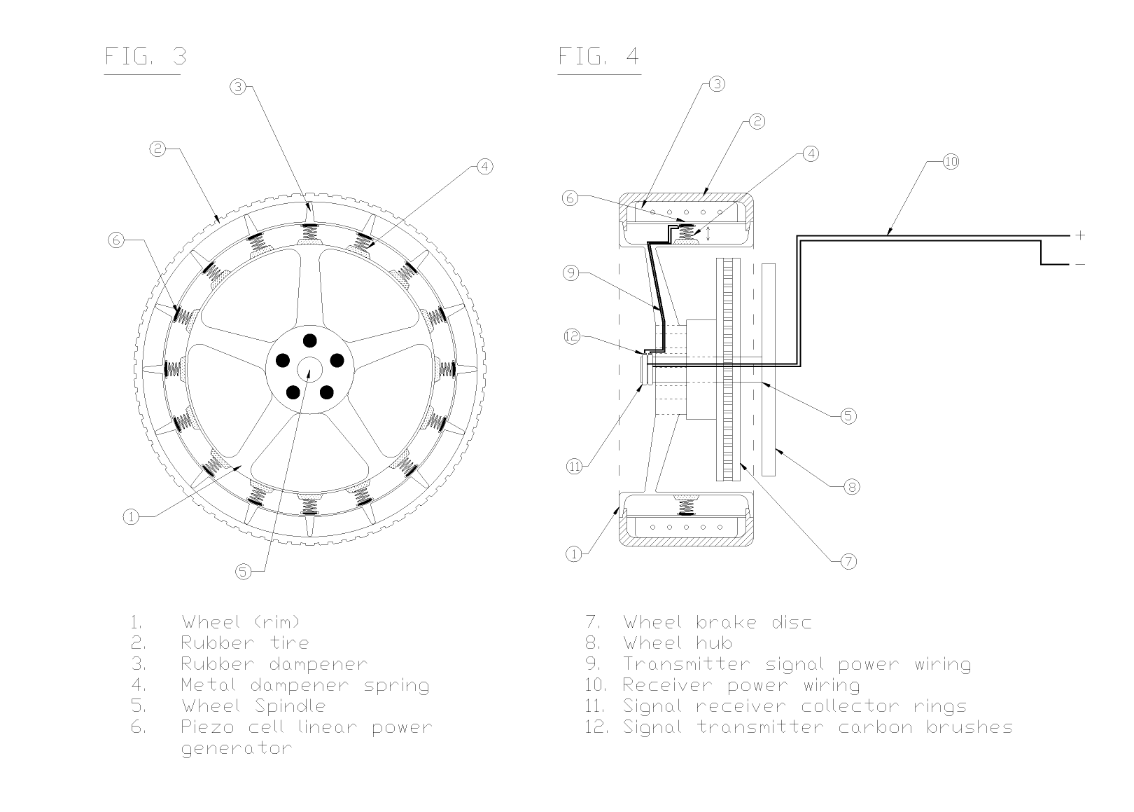

According to FIG. 3, the same configuration as with FIG. 1, except that the power generation is provided via the use of piezo cells 6. With this arrangement, the range of motion required to activate the generator 6 and produce an electric current is much less. The piezo cell 6 can be fixed rigid to the wheel 1, with all dampening methods, rubber or metal spring, 3 and 4 respectively attached between the piezo cell 6 and the inner circumference of the tire 2, or the piezo cell 6 can reside between the vibration and motion dampening methods, as seen in FIGS. 3 and 4. All transmission of the electric signal is accomplished as with FIG. 1.

According to FIG. 5, a similar configuration as with FIG. 3, except that the vibration and motion dampening is accomplished by utilizing an inflated inner tube 3 between the outer circumference of the wheel 1 and inner circumference of the tire 2, where the piezo cells 5 reside between the outer circumference of the inner tube 3 and the inner circumference of the tire 2. The transmission of the electric current from the piezo cell 5 occurs in the same manner as FIGS. 1 and 3, but there is no requirement for a dampening spring or rubber vanes to cushion the effect of excessive deformation of the tire 2 due to imperfections in the road surface.

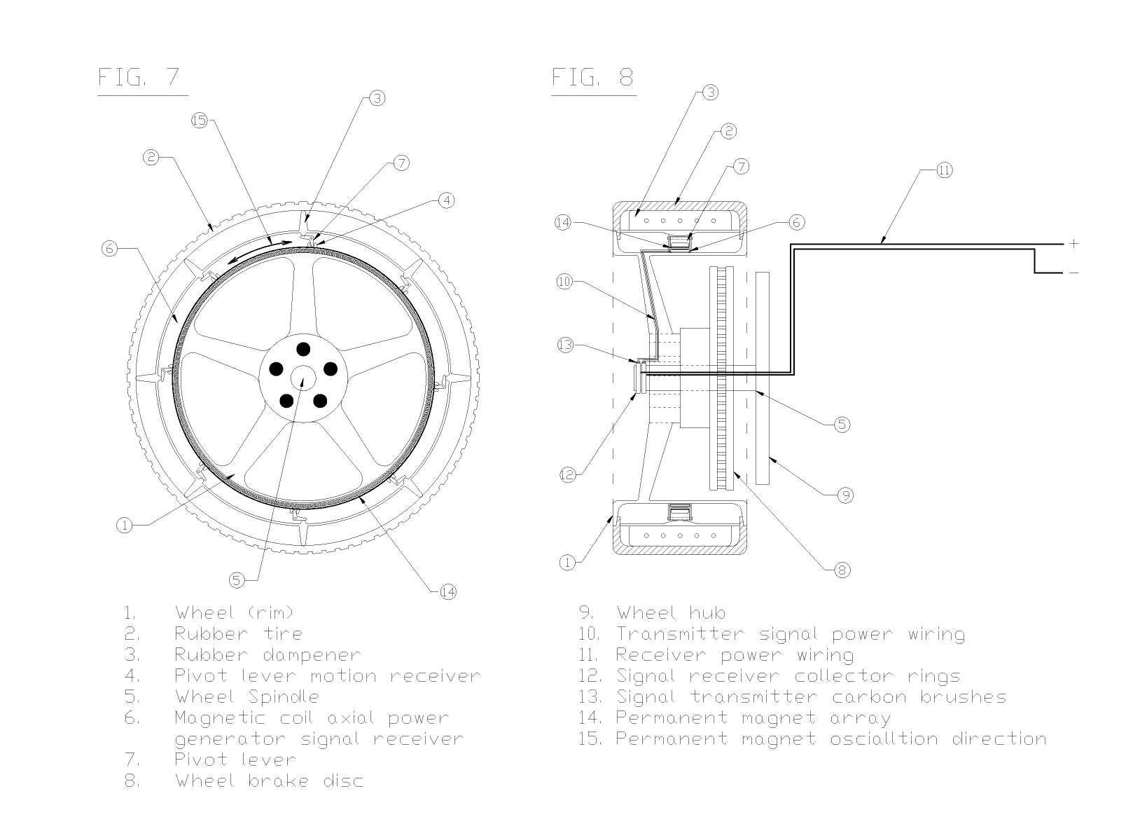

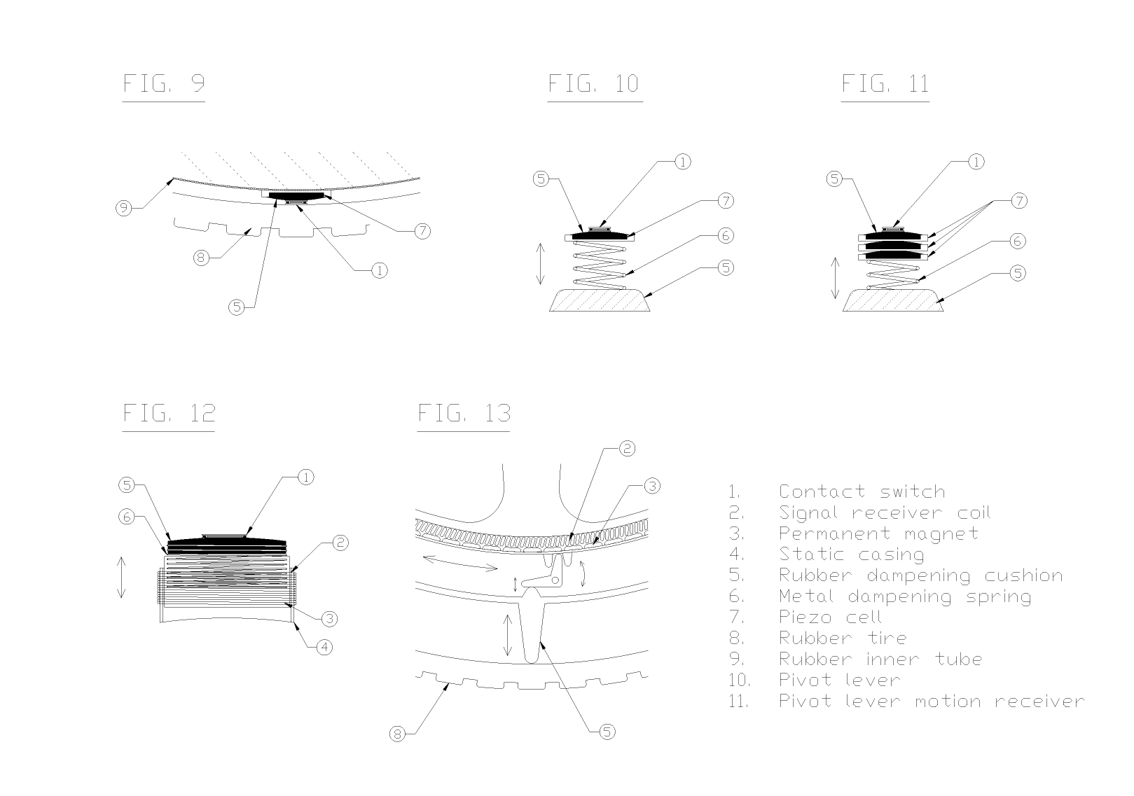

According to FIG. 7, a different method of power generation is employed, where a solid coiled ring 6 receives the effect of an oscillating magnetic field provided via permanent magnets attached to an outer ring 14 placed in close proximity to the coiled ring 6. The coiled ring 6 is fixed to the outer circumference of the wheel 1, where only one set of transmission wiring 10 is required since the magnetic coiled wire 6 is continuous. The outer ring array of permanent magnets 14, which is concentrically positioned outside of the coiled ring 6, providing minimal spacing to allow for maximum transference of the magnetic field to the coiled wiring 6. The magnet ring array 14 is permitted to oscillate relative to the coiled wiring 6 via any bearing assembly that allows for that type of motion. The oscillation of the magnet array 14 occurs as a consequence of the linear motion created by the contact of the tire 2 with the road surface, where the weight support by the wheel 1 deforms the tire sufficiently for this action to occur. To transform the linear motion of the tire's 2 deformation into an oscillating axial movement, at various radial points along the circumference of the wheel 1 and tire 2 assembly pivot levers 7 are introduced which are constructed in a 90 degree configuration with a pivot point at the vertex of the lever 7. The pivot lever 7 is fixed to the wheel 2 and is positioned with an alignment to the dampening vanes 3, where the dampening vanes 3 transmits the linear motion of the tire's deformation to the pivot lever 7 with a cushioned consideration for excessive range of deformation of the tire occurring from imperfections in the road surface. Since only one channel of current transmission occurs with the utilization of a continuous coiled ring 6, there is no need for contact or solid state switching. Transmission of the signal from the rotating wheel 1 and the static wheel axle spindle 5 is accomplished by utilizing a carbon brush assembly 13 electrically attached to the coiled ring 6 via the transmitter wiring 10, fixed rigid to the wheel 1, with the collector rings 12, fixed rigid to the wheel 5 spindle making contact with the carbon brushes 13 to receive the electrical current produced by the power generator 6 and 14, electrically connected via the receiver wiring 11 to the receiver, or vehicle.

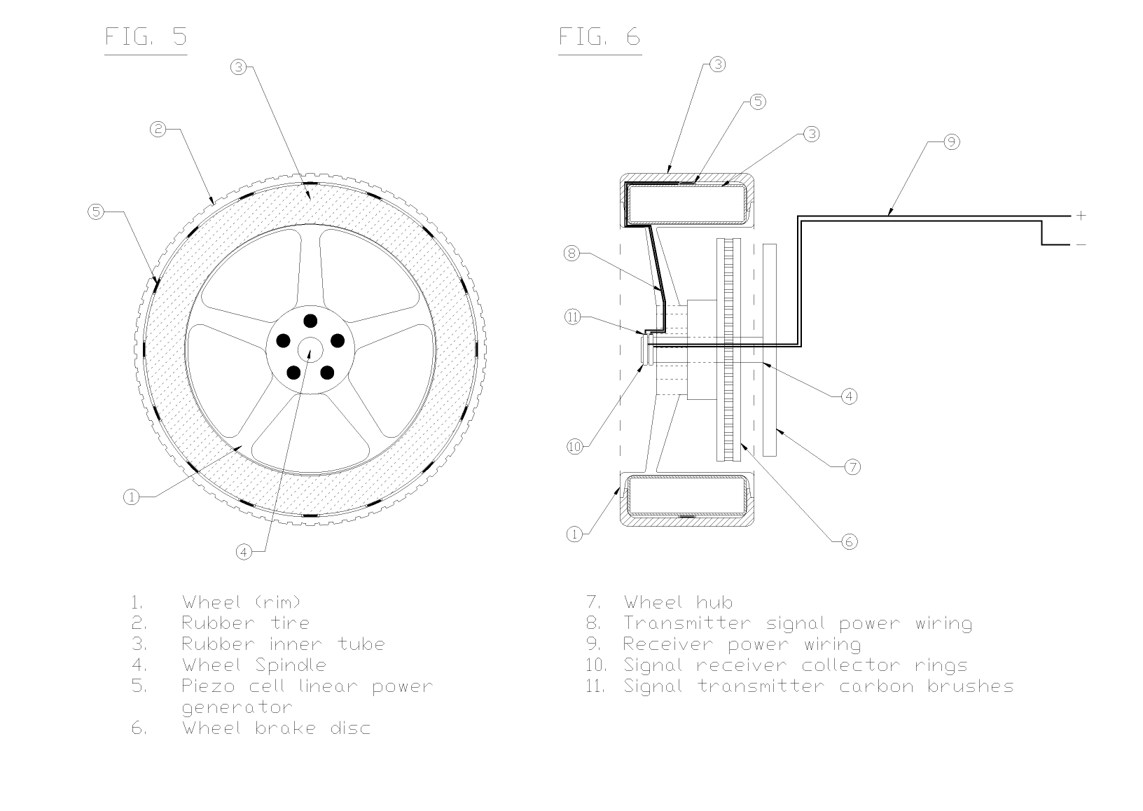

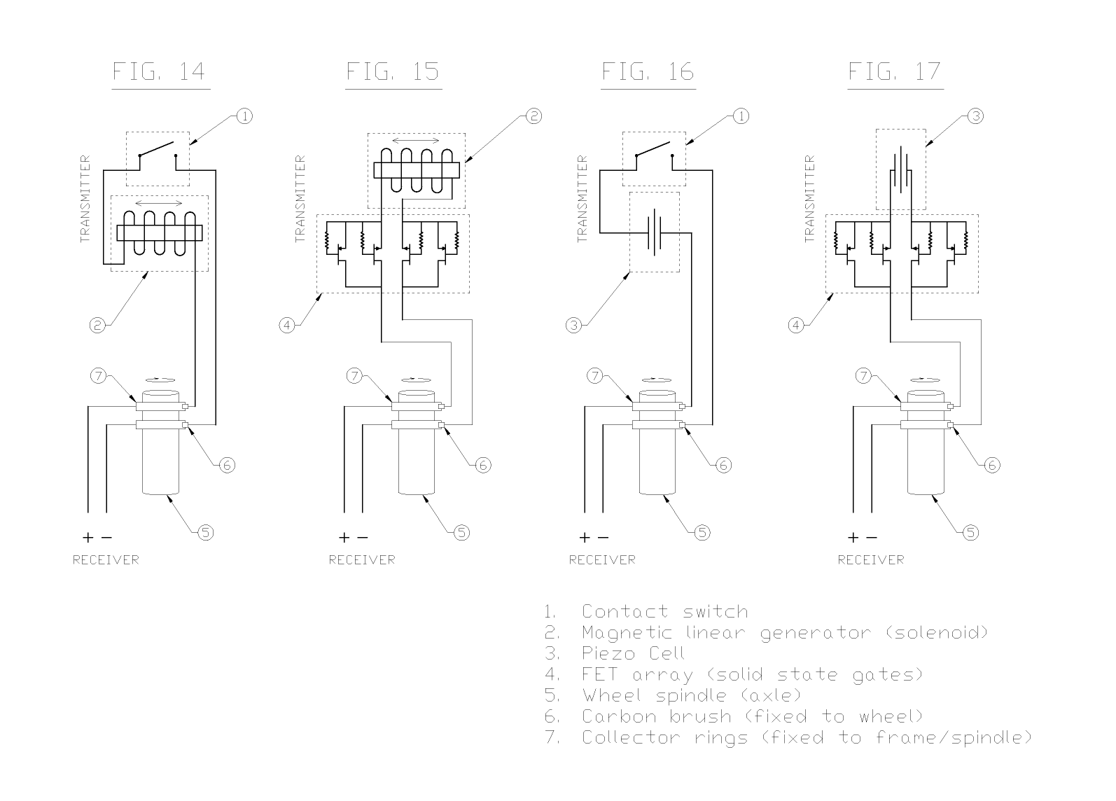

FIGS. 14, 15, 16, and 17 provide electrical schematics that reflect a basic understanding and concept of the wiring configuration required to achieve a closed circuit between the rotating wheel 1 (FIG. 1 through 8) and the wheel spindle, as well as consideration for having to exclude all other power generators in the array configurations that are not in contact with the pressure point at the road's surface. According to FIGS. 14 and 16, a contact switch 1 must first close for the circuit to close at that power generator. Otherwise there is no electrical signal which can be communicated in or out of the generator. The contact switch 1 is positioned between a power generator in the array and the pressure that activates it, in such a fashion that the switch 1 will close first before the generator is activated from that pressure. According to FIGS. 15 and 16, a solid state gate circuit assembly 4 is employed to ensure that only the power generator exposed to the pressure at the deformation of the tire 2 (FIG. 1 through 8) transmits a signal to the receiver. The field effect transistors (FET) which act as electric field activated diodes, are configured and applied in such a fashion that they recognize an alternating current occurring from the oscillating motion of the points selected along the circumference of the wheel assembly as they align with the weight of the vehicle on the surface of the road, and the deformation created at that point on the tire. The type of FET and resistor at the Vt point (voltage between the gate and the FET's input signal, normally 0.7 V) will be determined by the type of generator utilized, the application for the power generation assembly, and the electrical requirements of the vehicle.

What I claim as my invention is:

1. A wheel which supports the weight of a vehicle that utilizes the pressure of the weight which it is supporting and the rotation of the wheel to produce an electric current that will be transmitted to and received by the vehicle to provide an electric charge for the vehicle's electric requirements.

2. An arrangement in accordance with claim 1, wherein; the wheel is utilized for a vehicle configuration comprised of a rim supporting an inflated rubber tire with an enclosed array of solenoids circumscribed about the rim which detect and activate at the pressure point between the rim and the tire where the tire meets the support surface (road) to provide an electric current to the vehicle through the power generation created by the oscillating linear motion of its magnetic components within a wound electrical coil.

3. An arrangement in accordance with claim 1, wherein; the wheel is utilized for a vehicle configuration comprised of a rim supporting an inflated rubber tire with an enclosed array of piezo cells circumscribed about the rim which detect and activate at the pressure point between the rim and the tire where the tire meets the support surface (road) to provide an electric current to the vehicle through the power generation created by the oscillating linear motion of its bimetallic components.

4. An arrangement in accordance with claim 1, wherein; the wheel is utilized for a vehicle configuration comprised of a rim supporting a rubber tire with an array of piezo cells circumscribed about an inner tube inflated and enclosed within the rubber tire sandwiched between the inner tube and the tire which detect and activate at the pressure point between the inner tube and the tire where the tire meets the support surface (road) to provide an electric current to the vehicle through the power generation created by the oscillating linear motion of its bimetallic components.

5. An arrangement in accordance with claim 1, wherein; the wheel is utilized for a vehicle configuration comprised of a rim supporting an inflated rubber tire with an enclosed metal ring circumscribed about the rim wound with magnetic wire across its entire circumference fixed to the rim with an independent ring circumscribed and concentrically aligned around the magnetic wire, supporting permanent magnets inscribed within its entire circumference with an oscillating axial motion relative to the coil created by the linear deformation of the tire at the contact point where the weight of the vehicle meets the surface transmitted via a 90 degree lever to provide an electric current to the vehicle.

6. An arrangement in accordance with claim 2, 3, and 4, wherein; each electric current generator in the array utilizes a contact switch at the contact tip to close the circuit between the generator and the receiver, excluding all other generators during the pressure related activation where their circuit would remain open until the rotation of the wheel would position them at the pressure point where the wheel meets the road, only then closing the circuit and communicating the signal to the receiving end.

7. An arrangement in accordance with claim 2, 3, and 4, wherein; each electric current generator in the array transmits its signal through a solid state gate device which excludes all other generators in the circuit during the pressure related activation where their circuit would remain open until the rotation of the wheel would position them at the pressure point where the wheel meets the road, only then closing the circuit and communicating the signal to the receiving end.

8. An arrangement in accordance with claim 2, 3 and 5, wherein; rubber dampening veins are utilized to transmit the linear motion between the pressure point of the inflated tire to the electric generator to minimize the destruction of the electric current generation system in the event of a deflated tire by providing a dampened physical contact between the electric generator and the inner surface of the inflated rubber tire at the pressure point, more specifically where it comes into contact with the support surface (road).

9. An arrangement in accordance with claim 1, wherein; the communication of the electric current between the rotating wheel and the static frame where it is supported is accomplished via a brush assembly attached to the wheel and power generation assembly, with an electrical contact to the ring bearing assembly at the spindle, which is a rigid attachment to the frame providing a connection to the electrical requirements of the vehicle.

10. An arrangement in accordance with claim 1, wherein; the communication of the electric current between the rotating wheel and the static frame where it is supported is accomplished via an induction coil embedded within the circumference of the rim facing the vehicle providing a dynamic magnetic flux which is received by the static frame of the vehicle via a receiving coil positioned sufficiently close to the transmitting induction coil to efficiently accept the signal and contribute to the vehicle's electrical requirement without requiring a physical/electrical connection between the static frame and the rotating wheel.

11. An arrangement in accordance with claim 3, wherein; the piezo cells are circumscribed about the interior area between the rim and the inflated tire utilizing a dampening rubber cushion attached to that circumference of the rim supporting a dampening spring positioned between the rubber cushion and the piezo power generator allowing for a range of motion potentially created by an under inflated tire or road hazard.

12. An arrangement in accordance with claim 2, 3, and 4, wherein; each generator within the array can be comprised of multiple units mounted atop each other, wherein each assembly of the units utilizing the same pressure at the contact point to activate those generators to provide an increased electrical current for the power requirements of the receiver.

13. An arrangement in accordance with claims 3, 9 and 10, wherein; the array of piezo cells is embedded along the circumference of the rubber tire, where the rubber tire makes electrical contact with the wheel rim which supports the assembly to transmit the current to the receiver.

14. An arrangement in accordance with claim 2, 3, 4, and 5, wherein; the rubber tire is manufactured with protruding blocks or vanes of rubber or any other hard material along the outer circumference at each power generator location, to not only benefit from the additional traction, but provide increased linear motion and pressure for the power generators occurring as the blocks push into the wheel assembly by the weight of the vehicle at the contact point where the wheel assembly is supported by the road surface.

15. An arrangement in accordance with claim 5, wherein; any alternate method which can transform the linear displacement created by the deformation of the tire at the contact point where the weight meets the supporting surface (road) into an oscillating axial motion to activate the magnetic ring generator and provide an electric current for the receiver's power requirements.

16. An arrangement in accordance with claim 1, wherein; the wheel is not necessarily a rim supporting a rubber tire, but rather one solid rotating system, and does experience a pressure point at its tangent where the rotation of the wheel meets the surface which supports it, which allows for electric power production through the utilization of a pressure activated magnetic generator and/or piezo cell system.

17. An arrangement in accordance with claim 1, wherein; the wheel is not necessarily supporting the weight of a vehicle, but rather any machinery where it is exposed to a constant pressure point at the tangent of the wheel during the transfer of rotational energy and participates in a system that can utilize that electrical power generation as a useful contribution to the system.

18. An arrangement in accordance with claim 1, wherein; the electric current created by the power generation within the wheel system is utilized to activate an array of lights (neon, fluorescent, incandescent, LED, or electroluminescent) mounted along the wheel.

19. An arrangement in accordance with claim 9 and 18, wherein; the lighting system energized by the power generation system can be controlled from within the vehicle utilizing the collector rings and carbon brushes in reverse to send a signal and/or current back to the rim to communicate with the wheel mounted lights.

20. An arrangement in accordance with claim 10 and 18, wherein; the lighting system energized by the power generation system can be controlled from within the vehicle utilizing the induction coils in reverse to send a signal and/or current back to the rim to communicate with the wheel mounted lights.
